(19) United States
(12) Patent Application Publication
(10) Pub. No.: US 2014/0126637 A1
(43) Pub. Date: May 8, 2014

(54) SYSTEM AND METHOD FOR DECODING A VIDEO

(71) Applicant: NVIDIA CORPORATION, Santa Clara, CA (US)

(72) Inventors: XINYANG YU, Shanghai (CN); JINCHENG LI, Shanghai (CN); JINYUE LU, Shanghai (CN); MANINDRA PARHY, Fremont, CA (US)

(73) Assignee: NVIDIA CORPORATION, Santa Clara, CA (US)

(21) Appl. No.: 13/745,469

(22) Filed: Jan. 18, 2013

(30) Foreign Application Priority Data
Nov. 7, 2012 (CN) 201210440833.0

(51) Int. Cl. H04N 7/26

(52) U.S. Cl. CPC H04N 19/00951
USPC 375/240.16; 375/240.27

(57) ABSTRACT

A system and a method for decoding a video is disclosed by the present invention. The system comprises a controller, a parser and a decoder, wherein the controller is used for sending a control command to the parser and receiving a status report from the parser; the parser is used for parsing a video stream according to the control command and sending a parsed result to the decoder; and the decoder is used for decoding the parsed result. By using the system and the method for decoding a video provided by the present invention, errors in a video stream can be concealed during the decoding process of the video, and then a desired video output effect can be achieved at a receiving end.

### CROSS-REFERENCE TO RELATED APPLICATIONS

This application claims priority to Chinese Patent Application No. 201210440833.0, filed on Nov. 7, 2012, which is hereby incorporated herein by reference.

### BACKGROUND OF THE INVENTION

1. Field of the Invention

The present invention relates generally to a filed of video communication and, in particular, to a system and a method for decoding a video.

2. Description of the Related Art

Digital video technology is developing rapidly on today, and video compression is very important to digital transmission. This is because the transmitted video signals can be played continuously in real time so as to be accepted by people's visual sense only by improving transmission rate effectively. However, since transmission channels are not error free channels, errors always arise inevitably during the video transmission. Therefore, in order to achieve a desired video output effect, it is necessary to conceal errors in a video stream. If an error concealment is performed at an encoder, decoding errors caused by transmission errors of variable-length coding (VLC) code words can be roughly eliminated. But the cost is that the encoder's burden is increased. And available bandwidth is occupied so that the image quality is reduced relatively. Therefore, a system and a method for decoding a video is needed to solve the above problems.

### SUMMARY OF THE INVENTION

The present invention is related to a system and a method for decoding a video.

In one aspect of the invention, a system for decoding a video is disclosed. The system comprises a controller, a parser and a decoder, wherein the controller is used for sending a control command to the parser and receiving a status report from the parser; the parser is used for parsing a video stream according to the control command and sending a parsed result to the decoder; and the decoder is used for decoding the parsed result.

In a preferred embodiment of the present invention, the status report further comprises: a no-error status report for being returned to the controller by the parser when the parser detects no error or a slight error during the parsing; and an error status report for being returned to the controller by the parser when the parser detects a serious error during the parsing.

In a preferred embodiment of the present invention, the parser performs a saturating operation or a default operation when detecting the slight error during the parsing.

In a preferred embodiment of the present invention, the system further comprises a data register for storing an error type list containing the slight error and the serious error to be queried by the parser so as to determine to send the no-error status report or the error status report to the controller.

In a preferred embodiment of the present invention, the system further comprises a buffer register for storing an address of an error macro block detected by the parser during the parsing.

In a preferred embodiment of the present invention, the control command further comprises: a parse command for informing the parser to parse the video stream; and a concealment command for informing the parser to perform an error concealment for the video stream.

In a preferred embodiment of the present invention, the parse command further comprises a macro block number for starting the parsing, a macro block number for ending the parsing and a size of the video stream to be parsed.

In a preferred embodiment of the present invention, the concealment command further comprises a macro block number for starting the error concealment, a macro block number for ending the error concealment and an error concealment type.

In a preferred embodiment of the present invention, the macro block number for starting the error concealment and the macro block number for ending the error concealment are determined based on an error concealment mode.

In a preferred embodiment of the present invention, the error concealment mode further comprises: a slice mode for starting the error concealment from a current slice; a line mode for starting the error concealment from a current error macro block line; and a macro block mode for starting the error concealment from one or more macro blocks ahead of a current error macro block.

In a preferred embodiment of the present invention, the error concealment type further comprises: an intra concealment for decoding a current macro block using a vertical intra prediction mode; a zero-motion-vector concealment for decoding the current macro block using a zero motion vector; a Pskip-motion-vector concealment for decoding the current macro block using a Pskip motion vector; and a co-located-motion-vector concealment for decoding the current macro block using a co-located motion vector.

According to another aspect of the present invention, a method for decoding a video is also disclosed, comprising: sending a control command to a parser by a controller; parsing a video stream according to the control command by the parser; returning a status report to the controller by the parser; sending a parsed result to a decoder by the parser; and decoding the parsed result by the decoder.

In a preferred embodiment of the present invention, the status report further comprises: a no-error status report for being returned to the controller by the parser when the parser detects no error or a slight error during the parsing; and an error status report for being returned to the controller by the parser when the parser detects a serious error during the parsing.

In a preferred embodiment of the present invention, the parser performs a saturating operation or a default operation when detecting the slight error during the parsing.

In a preferred embodiment of the present invention, the control command further comprises: a parse command for informing the parser to parse the video stream; and a concealment command for informing the parser to perform an error concealment for the video stream.

In a preferred embodiment of the present invention, the parse command further comprises a macro block number for starting the parsing, a macro block number for ending the parsing and a size of the video stream to be parsed.

In a preferred embodiment of the present invention, the concealment command further comprises a macro block number for starting the error concealment, a macro block number for ending the error concealment and an error concealment type.

In a preferred embodiment of the present invention, the macro block number for starting the error concealment and the macro block number for ending the error concealment are determined based on an error concealment mode.

In a preferred embodiment of the present invention, the error concealment mode further comprises: a slice mode for starting the error concealment from a current slice; a line mode for starting the error concealment from a current error macro block line; and a macro block mode for starting the error concealment from one or more macro blocks ahead of a current error macro block.

In a preferred embodiment of the present invention, the error concealment type further comprises: an intra concealment for decoding a current macro block using a vertical intra prediction mode; a zero-motion-vector concealment for decoding the current macro block using a zero motion vector; a Pskip-motion-vector concealment for decoding the current macro block using a Pskip motion vector; and a co-located-motion-vector concealment for decoding the current macro block using a co-located motion vector.

By using the system and the method for decoding a video provided by the present invention, errors in a video stream can be concealed during the process of decoding the video, and then a desired video output effect can be achieved at a receiving end.

Additional features and advantages of the invention will be set forth in the description that follows, and in part will be apparent from the description, or may be learned by practice of the invention. The advantages of the invention will be realized and attained by the structure and the steps particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a structure diagram of a system for decoding a video according to a preferred embodiment of the present invention;

FIG. 2 illustrates a flow chart of a method for decoding a video according to a preferred embodiment of the present invention;

FIGS. 3a and 3b illustrates a schematic diagram of operations of a system for decoding a video respectively according to a preferred embodiment of the present invention.

### DETAILED DESCRIPTION

Example embodiments are described herein in the context of systems and methods for decoding videos. Those of ordinary skill in the art will realize that the following description is illustrative only and is not intended to be in any way limiting. Other embodiments will readily suggest themselves to those skilled in the art having the benefit of this disclosure. Reference will now be made in detail to implementations of the example embodiments as illustrated in the accompanying drawings. The same reference numbers will be used to the extent possible throughout the drawings and the following description to refer to the same or like items.

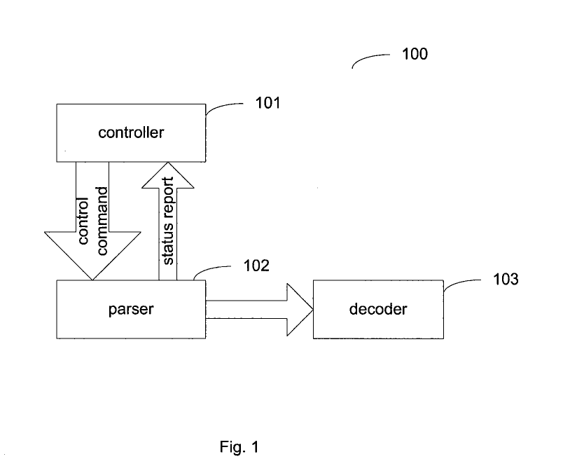

According to one aspect of the present invention, a system for decoding a video is disclosed. FIG. 1 illustrates a structure diagram of a system 100 for decoding a video according to a preferred embodiment of the present invention. As shown in FIG. 1, the system 100 for decoding a video comprises a controller 101, a parser 102 and a decoder 103, wherein the controller 101 is used for sending a control command to the parser 102 and receiving a status report from the parser 102; the parser 102 is used for parsing a video stream according to the control command and sending a parsed result to the decoder 103; and the decoder 103 is used for decoding the parsed result.

Specifically, the controller 101 is used for controlling the parsing process of the parser 102. It sends a control command to the parser 102 to make the parser 102 to well parse a video stream, and it also receives a status report from the parser 102 and makes a response on the basis of the status report.

According to one preferred embodiment of the present invention, the control command from the controller 101 may be a command for defining which macro blocks to be parsed, whether, when and how to perform an error concealment and so on. Table 1 shows various types of control commands.

As shown in Table 1, the control commands may comprise a parse command and a concealment command, wherein the parse command is used for informing the parser 102 to parse a video stream, and the concealment command is used for informing the parser 102 to perform an error concealment for the video stream. The parse command may comprise a macro block number for starting the parsing, a macro block number for ending the parsing and a size of the video stream to be parsed. The concealment command may comprise a macro block number for starting the error concealment, a macro block number for ending the error concealment and an error concealment type. On the basis of the parse command and the concealment command, the parser 102 can clearly know which macro blocks should be parsed or concealed, and thus the efficiency and accuracy of the subsequent decoding by the decoder 103 can be improved.

TABLE 1
the types of control commands

| Command | | |
|---|---|---|
| Type | Parameter | Note |
| a parse | start_decode_mb | defining a macro block number for |
| command | | starting the parsing |
| | end_decode_mb | defining a macro block number for |
| | | ending the parsing |
| | bit_stream_size | defining a size of the video stream to |
| | | be parsed |
| a | conceal_start_mb | defining a macro block number for |
| concealment | | starting an error concealment |
| command | conceal_end_mb | defining a macro block number for |
| | | ending an error concealment |
| | conceal_type | defining an error concealment type |

The status report returned by the parser 102 may comprise a no-error status report and an error status report, wherein the no-error status report is used for being returned to the controller 101 by the parser 102 when the parser 102 detects no error or a slight error during the parsing, and the error status report is used for being returned to the controller 101 by the parser 102 when the parser 102 detects a serious error during the parsing. It can make the controller 101 learn whether there is a serious error during the current parsing process that the parser 102 returns a status report to the controller 101. Then the controller 101 can make an appropriate response (e.g. send a concealment command) and control the parsing process of the parser 102 more easily. Thus, the accuracy of the parsed result sent to the decoder 103 is improved and in turn the accuracy of the decoded result is ensured.

Here, errors may be classified into two types: a slight error and a serious error. Wherein, the slight error may be a certain context or syntax error. Taking H.264 as an example, errors like that a macro block type (mb_type) exceeds its range or that a motion vector exceeds the boundary of a picture can be taken as slight errors. The slight error is mainly produced by an encoder or a decoder having bugs. While the serious error may mean that the raw data stream has been ruined. Still taking H.264 as an example, some error values decoded based on Context-Based Adaptive Binary Arithmetic Coding (CABAC) or Context-Based Adaptive Variable Length Coding (CAVLC) are mainly because the raw data stream (for example, in a local disk, from the Internet) is ruined. Since the variable-length decoding (VLD) is data dependent in a video decoder, slight errors usually do not appear too much in a slice of the image data of a video, and they do not crash a decoder either. While a serious error can cause lots of slight errors in a slice and it can also crash a decoder. Therefore, for a serious error, an appropriate error concealment solution should be taken.

According to one preferred embodiment of the present invention, the system 100 may also comprises a data register (not shown in FIG. 1) for storing an error type list containing the slight error and the serious error to be queried by the parser 102 so as to determine to send the no-error status report or the error status report to the controller 101. When detecting an error during the parsing, the parser 102 can determine whether the error is a slight error or a serious error on the basis of the error type list stored in the data register. If the detected error is a slight error, the parser 102 returns a no-error status report. If the detected error is a serious error, the parser 102 returns an error status report.

Furthermore, for different video decoding standards, the definitions of the above error statuses are different. Taking H.264 as an example, Table 2 shows the definitions of error statuses.

TABLE 2
the definitions of error statuses in H.264

| Name | Value |
|---|---|
| H264_SLICE_END_AT_SMALLER_MB_ADDR | 0x00000001 |
| H264_MB_SKIP_RUN | 0x00000002 |
| H264_MB_TYPE_RANGE_EXCEEDED_FOR_I_SLICE | 0x00000004 |
| H264_MB_TYPE_RANGE_EXCEEDED_FOR_P_SLICE | 0x00000008 |
| H264_MB_TYPE_RANGE_EXCEEDED_FOR_B_SLICE | 0x00000010 |
| H264_MB_TYPE_RANGE_EXCEEDED_FOR_SI_SLICE | 0x00000020 |
| H264_MB_TYPE_RANGE_EXCEEDED_FOR_SP_SLICE | 0x00000040 |
| H264_MB_QP_DELTA_OUT_OF_RANGE | 0x00000080 |
| H264_RESIDUAL_COEFF_COUNT | 0x00000100 |
| H264_INVALID_SUB_MB_TYPE | 0x00000200 |
| H264_INVALID_MB_REF_IDX_L0 | 0x00000400 |
| H264_INVALID_MB_REF_IDX_L1 | 0x00000800 |
| H264_INVALID_SUB_MB_REF_IDX_L0 | 0x00001000 |
| H264_INVALID_SUB_MB_REF_IDX_L1 | 0x00002000 |
| H264_INVALID_VLC_TOKEN0 | 0x00004000 |
| H264_INVALID_VLC_TOKEN1 | 0x00008000 |
| H264_INVALID_VLC_TOKEN2 | 0x00010000 |
| H264_INVALID_VLC_TOKEN3 | 0x00020000 |
| H264_INVALID_VLC_TOTAL_ZEROS | 0x00040000 |
| H264_INVALID_VLC_RUN_BEFORE | 0x00080000 |
| H264_INVALID_FIXED_PTRN_BIT_STRING | 0x00100000 |
| H264_INVALID_CODED_BLOCK_PATTERN | 0x00200000 |
| H264_WT_PRED_LARGE_LUMA_LOG_WD | 0x00400000 |
| H264_WT_PRED_LARGE_CHR_LOG_WD | 0x00800000 |
| H264_WT_PRED_INVALID_LUMA_WEIGHT | 0x01000000 |
| H264_WT_PRED_INVALID_LUMA_OFFSET | 0x02000000 |
| H264_WT_PRED_INVALID_CHROMA_WEIGHT | 0x04000000 |
| H264_WT_PRED_INVALID_CHROMA_OFFSET | 0x08000000 |
| EXCEED_SLICE_OFFSET_LIMIT | 0x10000000 |
| MB_DATA_EXCEED_EDOB_FIFO_LIMIT | 0x20000000 |
| UNCLASSIFIED | 0x40000000 |
| SW_ERROR | 0x80000000 |

The parser 102 is used for parsing the video stream on the basis of the control command sent from the controller 101 and sending the parsed result to the decoder 103. The parsing the video stream performed by the parser 102 may include variable-length decoding (VLD) performed in a codec in a video standard such as H.264, MPEG-2 and VC1. VLD is a reverse process of variable-length coding (VLC). It extracts the variable-length code words from a group of continuous code streams and transforms them into corresponding source information. When detecting a slight error, the parser 102 performs a saturating operation or a default operation. If a parsed result is not in its definition range, the saturating operation may be to modify the result to a maximum value of the definition range, while the default operation may be to modify the result to a minimum value of the definition range. For a slight error, the parser 102 does not need to send an error status report to the controller 101, and it may only need to perform simple processing to modify the error, which can improve the operation efficiency of the whole system.

According to one preferred embodiment of the present invention, the system 100 may also comprises a buffer register (not shown in FIG. 1) for storing an address of an error macro block detected by the parser 102 during the parsing. When detecting a serious error, the parser 102 sends an error status report to the controller 101 and writes an address of the error macro block into the buffer register. After receiving the error status report, the controller 101 can poll the buffer register to get the address of the error macro block so as to get ready for calculating the beginning number and the end number of the macro blocks that need to be concealed.

According to one preferred embodiment of the present invention, the macro block number for starting the error concealment and the macro block number for ending the error concealment in the concealment command can be determined based on an error concealment mode.

According to one preferred embodiment of the present invention, the error concealment mode can further comprise a slice mode, a line mode and a macro block mode. Wherein, the slice mode is used for starting the error concealment from a current slice; the line mode is used for starting the error concealment from a current error macro block line; and the macro block mode is used for starting the error concealment from one or more macro blocks ahead of a current error macro block. The selection of an error concealment mode can base on the quality of the raw video stream. When the quality of the raw data stream is good, the macro block mode can be selected. When the quality of the raw data stream is bad, the slice mode can be selected. The line mode is between the slice mode and the macro block mode. Table 3 shows the error concealment modes of error concealments.

TABLE 3
the error concealment modes of error concealments

| Concealment | |
|---|---|
| mode | Note |
| a slice mode | starting the error concealment from a current slice |
| a line mode | starting the error concealment from a current error |
| | macro block line |
| a macro block | starting the error concealment from one or more macro |
| mode | blocks ahead of a current error macro block, here |
| | ‘certain’ is programmable, 3 or 5 etc. |

According to one preferred embodiment of the present invention, the error concealment type in the concealment command may further comprise an intra concealment, a zero-motion-vector concealment, a Pskip-motion-vector concealment and a co-located-motion-vector concealment. Wherein the intra concealment is used for decoding a current macro block using a vertical intra prediction mode; the zero-motion-vector concealment is used for decoding the current macro block using a zero motion vector; the Pskip-motion-vector concealment is used for decoding the current macro block using a Pskip motion vector; and the co-located-motion-vector concealment is used for decoding the current macro block using a co-located motion vector. The selection of an error concealment type can be based on the type of the raw video stream. When the current frame of the raw data stream is an I frame, the intra concealment type can be selected. When adjacent images of the raw data stream dose not move so much, the zero-motion-vector concealment type can be selected. When the current frame of the raw data stream is a P frame, the Pskip-motion-vector concealment type can be selected. When the current frame of the raw data stream is a B frame, the co-located-motion-vector concealment type can be selected. Table 4 shows the error concealment types of an error concealment.

TABLE 4
the error concealment types of error concealments

| Error concealment | |
|---|---|
| type | Note |
| an intra concealment | decoding a current macro block using a vertical |
| | intra prediction mode |
| a zero-motion-vector | decoding the current macro block using a zero |
| concealment | motion vector |
| a Pskip-motion-vector | decoding the current macro block using a Pskip |
| concealment | motion vector |
| a co-located-motion- | decoding the current macro block using a co- |
| vector concealment | located motion vector |

The controller 101 selects an error concealment mode on the basis of the quality of the raw video data stream, calculates the macro block numbers for starting and ending the error concealment according to the address of the error macro block and selects an error concealment type on the basis of the type of the raw video data to form a concealment command to send to the parser 102, and sends a parse command to the parser 102 again. On the basis of the concealment command and the parse command sent by the controller 101, the parser 102 re-parses the slice in which the error macro block was detected in the last parsing and conceals the error. It should be noted that the ‘re-parse’ here means that only the correct macro blocks in the slice in which an error macro block was detected are parsed again, and the parsed result of the error macro block is replaced by the correct parsed result which has been parsed (for example, the parsed result in a corresponding location of the last slice). Then the formed parsed result is sent to the decoder 103, and thus the error concealment is completed.

The decoder 103 is used for performing the rest part except VLD in codec decoding, that is to decode the parsed result from the parser 102. The decoding process may comprise inverse quantization, inverse transformation, motion compensation and/or filter and so on.

It should be noted that in the whole decoding process, the work of detecting an error and concealing the error is performed at the controller 101 and the parser 102, and the decoder 103 even does not know that there has been an error in the video stream.

According to another aspect of the present invention, a method for decoding a video is also disclosed. The method comprises: sending a control command to a parser by a controller; parsing a video stream according to the control command by the parser; returning a status report to the controller by the parser; sending a parsed result to a decoder by the parser; and decoding the parsed result by the decoder.

According to one preferred embodiment of the present invention, the control command sent to the parser by the controller may comprise a parse command and a concealment command. Wherein, the parse command is used for informing the parser to parse the video stream, and the concealment command is used for informing the parser to perform an error concealment for the video stream.

According to one preferred embodiment of the present invention, the parse command may comprises a macro block number for starting the parsing, a macro block number for ending the parsing and a size of the video stream to be parsed. The concealment command may comprise a macro block number for starting the error concealment, a macro block number for ending the error concealment and an error concealment type.

According to one preferred embodiment of the present invention, the status report may further comprise a no-error status report and an error status report. Wherein, the no-error status report is used for being returned to the controller by the parser when the parser detects no error or a slight error during the parsing; and the error status report is used for being returned to the controller by the parser when the parser detects a serious error during the parsing.

According to one preferred embodiment of the present invention, the parser performs a saturating operation or a default operation when detecting the slight error during the parsing.

According to one preferred embodiment of the present invention, the macro block number for starting the error concealment and the macro block number for ending the error concealment in a concealment command are determined based on an error concealment mode.

According to one preferred embodiment of the present invention, the error concealment mode may further comprise a slice mode, a line mode and a macro block mode. Wherein, the slice mode is used for starting the error concealment from a current slice; the line mode is used for starting the error concealment from a current error macro block line; and the macro block mode is used for starting the error concealment from one or more macro blocks ahead of a current error macro block.

According to one preferred embodiment of the present invention, the error concealment type of the concealment command may further comprise an intra concealment, a zero-motion-vector concealment, a Pskip-motion-vector concealment and a co-located-motion-vector concealment. Wherein the intra concealment is used for decoding a current macro block using a vertical intra prediction mode; the zero-motion-vector concealment is used for decoding the current macro block using a zero motion vector; the Pskip-motion-vector concealment is used for decoding the current macro block using a Pskip motion vector; and the co-located-motion-vector concealment is used for decoding the current macro block using a co-located motion vector.

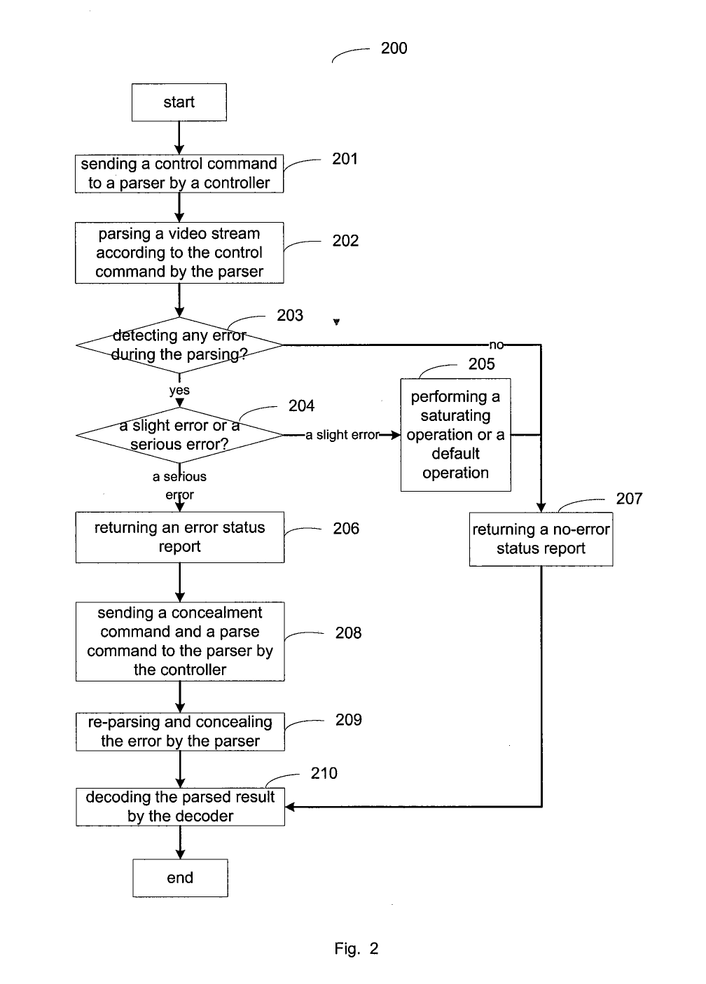

FIG. 2 illustrates a flow chart of a method 200 for decoding a video according to a preferred embodiment of the present invention.

As shown in FIG. 2, at step 201, a parse command is sent to a parser by a controller to inform the parser which macro blocks need to be parsed.

At step 202, the macro blocks to be parsed are parsed by the parser according to the parse command sent by the controller. That is, VLD is performed.

At step 203, detecting whether there is an error in the parsing process.

If no error is detected, turn to step 207 to return a no-error status report to the controller to inform the controller that there is no error in the parsing process and the command to parse the next slice can be sent. And then turn to step 210 to decode the parsed result, and the whole process is over.

If an error is detected, turn to step 204. Here, errors may be classified into two types: a slight error and a serious error. Wherein, the slight error may be a certain context or syntax error. Taking H.264 as an example, errors like that a macro block type (mb_type) exceeds its range or that a motion vector exceeds the boundary of a picture can be taken as slight errors. The slight error is mainly produced by an encoder or decoder having bugs. While the serious error may mean that the raw data stream has been ruined. Still taking H.264 as an example, some error values decoded based on Context-Based Adaptive Binary Arithmetic Coding (CABAC) or Context-Based Adaptive Variable Length Coding (CAVLC) are mainly because the raw data stream (for example, in a local disk, from the Internet) is ruined. Since the variable-length decoding (VLD) is data dependent in a video decoder, slight errors usually do not appear too much in a slice of the image data of a video, and they do not crash a decoder either. While a serious error can cause lots of slight errors in a slice and it can also crash a decoder. Therefore, for a serious error, an appropriate error concealment solution should be taken.

At step 204, determining whether the error detected in the parsing is a slight error or a serious error. The method for determining can be that the parser queries a data register which stores an error type list configured by the controller so as to determine whether the detected error is a slight error or a serious error. By the query, if the detected error is determined to be a slight error, turn to step 205, and then to step 207. If the detected error is determined a serious error, turn to step 206.

At step 205, the parser performs a saturating operation or a default operation regarding to the error which has been determined to be a slight error. If a parsed result is not in its definition range, for example, the saturating operation may be to modify the result to the maximum value of the definition range, while the default operation may be to modify the result to the minimum value of the definition range.

At step 206, since the detected error has been determined to be a serious error, the parser performs the following operations: returning an error status report to the controller, writing the address of the error macro block into a buffer register, stopping the parsing, waiting the controller to send a concealment command and sending head information of subsequent macro blocks to the decoder.

At step 207, since it is determined that there is no error in the parsing process, a no-error status report is returned to the controller.

At step 208, the controller receives an error status report from the parser, and then it gets the address of the error macro block by polling the buffer register. Then it selects an error concealment mode, calculates the beginning location and the end location of the macro blocks to be concealed according to the address of the error macro block and selects an error concealment type to form a concealment command to send to the parser, and sends a parse command again. Here, the error concealment mode may comprise a slice mode, a line mode and a macro block mode. The error concealment type may comprise an intra concealment, a zero-motion-vector concealment, a Pskip-motion-vector concealment and a co-located-motion-vector concealment.

At step 209, on the basis of the concealment command and the parse command sent by the controller, the parser re-parses the slice in which an error macro block was detected in the last parsing and conceals the error. It should be noted that the ‘re-parse’ here means that only the correct macro blocks in the slice in which an error macro block was detected are parsed again, and the parsed result of the error macro block is replaced by the correct parsed result which has been parsed (for example, the parsed result in a corresponding location of the last slice). Then the error concealment is completed.

At step 210, the decoder decodes the parsed result from the parser. That is the decoder performing the rest part except VLD in video decoding. For example, the decoder performs inverse quantization, inverse transformation, motion compensation or filter and so on to reconstruct the video data. And then, the whole decoding process is over.

It should be noted that in the whole decoding process, the work of detecting an error and concealing an error is performed at the controller and the parser, and the decoder even does not know that there has been an error in the video stream.

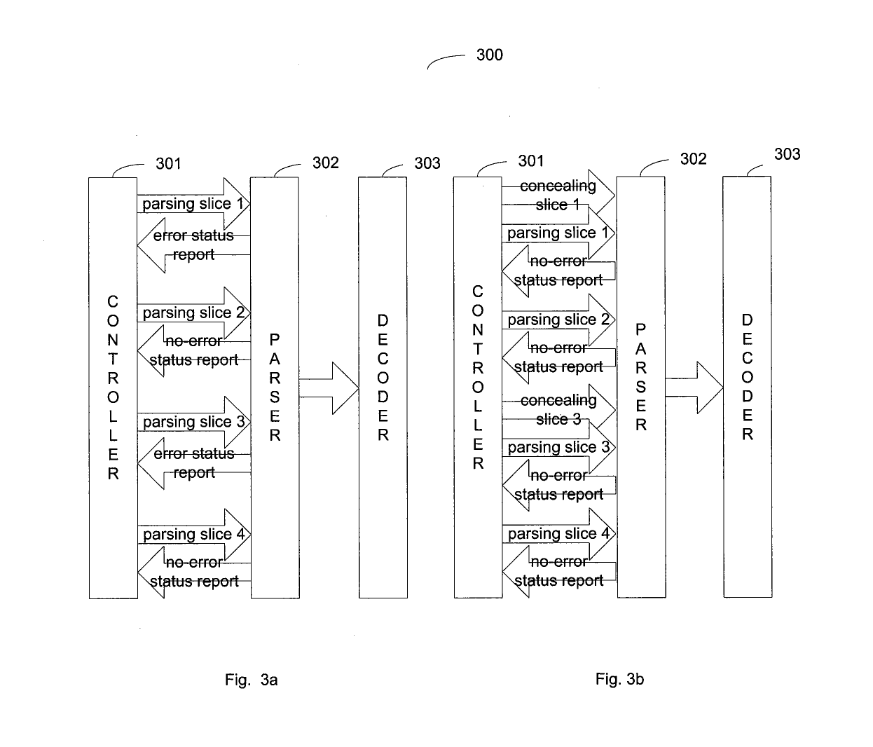

FIGS. 3a and 3b illustrates a schematic diagram of operations of a system 300 for decoding a video respectively according to a preferred embodiment of the present invention.

As shown in FIGS. 3a and 3b, the system 300 for decoding a video comprises a controller 301, a parser 302 and a decoder 303. The first set of operations is used for error detecting, as shown in FIG. 3a. The second set of operations is used for an error concealment, as shown in FIG. 3b.

The system 300 for decoding a video decodes a video which is divided into four slices. In FIG. 3a, the controller 301 sends four parse commands to the parser 302 to inform the parser 302 to parse the four slices of the video stream. On the basis of the parse commands from the controller 301, the parser 302 parses each slice. When parsing the first slice and the third slice, the parser 302 detects lots of errors and determines that there are serious errors. So the parser 302 returns error status reports regarding to the first slice and the third slice and no-error status reports regarding to the second slice and the fourth slice to the controller 301. In addition, the parser 302 sends the parsed result to the decoder 303, and the decoder 303 decodes the parsed result. Since there are errors in the parsing process, the system 300 for decoding a video starts the second set of the operations. That is an error concealment. As shown in FIG. 3b, for the first slice with errors, the controller 301 polls a buffer register (not shown in the FIG. 3b) to get the address of the error macro block written by the parser 302 on the basis of the error status report sent by the parser 302, then selects an error concealment mode to calculate the beginning location and the end location of the macro blocks to be concealed in the first slice and selects an error concealment type to form a concealment command to send to the parser 302, and sends a parse command again to make the parser 302 to re-parse the correct macro blocks and conceal the error macro blocks on the basis of the concealment command. Similarly, the process for the third slice is the same. For the second slice and the fourth slice with no error, the controller 301 sends the same parse commands as the parse commands in the first set of the operations, and then the parser 302 re-parses the second slice and the fourth slice. After completing the parsing of all the slices, the parser 302 sends the parsed result to the decoder 303. The decoder 303 decodes the parsed result to reconstruct the raw video data.

By using the system and the method for decoding a video provided by the present invention, errors in a video stream can be concealed during the decoding process of the video, and then a desired video output effect can be achieved at a receiving end.

It should be appreciated that various modifications, adaptations and alternative embodiments thereof may be made within the scope and spirit of the present invention. The invention is further defined by the following claims.

1. A system for decoding a video, comprising:
a controller;
a parser; and
a decoder, wherein
the controller is used for sending a control command to the parser and receiving a status report from the parser;
the parser is used for parsing a video stream according to the control command and sending a parsed result to the decoder; and
the decoder is used for decoding the parsed result.

2. The system of claim 1, wherein the status report further comprises:
a no-error status report for being returned to the controller by the parser when the parser detects no error or a slight error during the parsing; and
an error status report for being returned to the controller by the parser when the parser detects a serious error during the parsing.

3. The system of claim 2, wherein the parser performs a saturating operation or a default operation when detecting the slight error during the parsing.

4. The system of claim 2, further comprising a data register for storing an error type list containing the slight error and the serious error to be queried by the parser so as to determine to send the no-error status report or the error status report to the controller.

5. The system of claim 1, further comprising a buffer register for storing an address of an error macro block detected by the parser during the parsing.

6. The system of claim 1, wherein the control command further comprises:
a parse command for informing the parser to parse the video stream; and
a concealment command for informing the parser to perform an error concealment for the video stream.

7. The system of claim 6, wherein the parse command further comprises a macro block number for starting the parsing, a macro block number for ending the parsing and a size of the video stream to be parsed.

8. The system of claim 6, wherein the concealment command further comprises a macro block number for starting the error concealment, a macro block number for ending the error concealment and an error concealment type.

9. The system of claim 8, wherein the macro block number for starting the error concealment and the macro block number for ending the error concealment are determined based on an error concealment mode.

10. The system of claim 9, wherein the error concealment mode further comprises:
a slice mode for starting the error concealment from a current slice;
a line mode for starting the error concealment from a current error macro block line; and
a macro block mode for starting the error concealment from one or more macro blocks ahead of a current error macro block.

11. The system of claim 8, wherein the error concealment type further comprises:
an intra concealment for decoding a current macro block using a vertical intra prediction mode;
a zero-motion-vector concealment for decoding the current macro block using a zero motion vector;
a Pskip-motion-vector concealment for decoding the current macro block using a Pskip motion vector; and
a co-located-motion-vector concealment for decoding the current macro block using a co-located motion vector.

12. A method for decoding a video, comprising:
sending a control command to a parser by a controller;
parsing a video stream according to the control command by the parser;
returning a status report to the controller by the parser;
sending a parsed result to a decoder by the parser; and
decoding the parsed result by the decoder.

13. The method of claim 12, wherein the status report further comprises:
a no-error status report for being returned to the controller by the parser when the parser detects no error or a slight error during the parsing; and
an error status report for being returned to the controller by the parser when the parser detects a serious error during the parsing.

14. The method of claim 13, wherein the parser performs a saturating operation or a default operation when detecting the slight error during the parsing.

15. The method of claim 12, wherein the control command further comprises:
a parse command for informing the parser to parse the video stream; and
a concealment command for informing the parser to perform an error concealment for the video stream.

16. The method of claim 15, wherein the parse command further comprises a macro block number for starting the parsing, a macro block number for ending the parsing and a size of the video stream to be parsed.

17. The method of claim 15, wherein the concealment command further comprises a macro block number for starting the error concealment, a macro block number for ending the error concealment and an error concealment type.

18. The method of claim 17, wherein the macro block number for starting the error concealment and the macro block number for ending the error concealment are determined based on an error concealment mode.

19. The method of claim 18, wherein the error concealment mode further comprises:
a slice mode for starting the error concealment from a current slice;
a line mode for starting the error concealment from a current error macro block line; and
a macro block mode for starting the error concealment from one or more macro blocks ahead of a current error macro block.

20. The method of claim 17, wherein the error concealment type further comprises:
an intra concealment for decoding a current macro block using a vertical intra prediction mode;
a zero-motion-vector concealment for decoding the current macro block using a zero motion vector;
a Pskip-motion-vector concealment for decoding the current macro block using a Pskip motion vector; and
a co-located-motion-vector concealment for decoding the current macro block using a co-located motion vector.
